(19) United States
(12) Patent Application Publication
(10) Pub. No.: US 2017/0159435 A1
(43) Pub. Date: Jun. 8, 2017

(54) System for Filtering the Fresh Air Flowing in a Tunnel and/or the Exhaust Gases Flowing out Therefrom

(71) Applicants: Giorgio MICHELETTI, Sant'Ambrogio di Valpolicella (VR) (IT); Erardo Mateo MAYER, Monza (MB) (IT)

(72) Inventors: Giorgio MICHELETTI, Sant'Ambrogio di Valpolicella (VR) (IT); Erardo Mateo MAYER, Monza (MB) (IT)

(21) Appl. No.: 15/320,889

(22) PCT Filed: Jun. 25, 2015
(86) PCT No.: PCT/IB2015/054789

§ 371 Date: Dec. 21, 2016

(30) Foreign Application Priority Data
Jun. 25, 2014 (IT) VI2014A000164

(51) Int. Cl. E21F 1/00; B01D 39/14; A62C 99/00; A62C 3/02; A62C 2/06; B01D 47/06; B01D 46/48

(52) U.S. Cl. CPC E21F 1/003; B01D 47/06; B01D 39/14; B01D 46/48; A62C 3/0221; A62C 3/14; A62C 99/0072; B01D 2279/35

(57) ABSTRACT

A system for the treatment of exhaust gases flowing in and/or flowing out from a tunnel (T) overlying a roadway (R) through a ventilation duct (TV). The system comprises: filtering means (20) to filter the exhaust gases passing through the ventilation duct (TV); fan means (V) to force the evacuation of exhaust gases from the tunnel (T) towards the outer environment or the inflow of the exhaust gases from the outer environment into the tunnel (T) through the ventilation duct (TV); detecting means (10) of at least one parameter of the exhaust gases; control means (30) to activate the filtering means (20) in response to the detection by the first (10) of the exceeding of a predetermined threshold value of the at least one parameter. The filtering means (20) comprise at least one filtering unit (20′, 20″, 20′″) that includes: at least one water reservoir (21); pumping means which include at least one high pressure pump (22); a plurality of high pressure nozzles (24) to spray atomized water into drops having an average diameter lower than 500 μm, preferably lower than 250 μm, and at a minimum working pressure of 150 bar, preferably at a minimum working pressure of 200 bar; a line of fluid connection (25) of said at least one water reservoir (21) with said high pressure nozzles (24) passing through said pumping means (22).

### FIELD OF APPLICATION

The present invention is generally applicable to the technical field of the civil engineering and it particularly relates to a system for filtering the fresh air flowing in a tunnel and/or the exhaust gases flowing out therefrom, the tunnel being particularly of railway, road or motorway type.

More particularly, the invention allows to filter the exhaust gases and/or the fresh air through high pressure atomized water, starting from 150 bar.

### BACKGROUND OF THE INVENTION

As known, in case of fire, gas leak or similar accident in a road, motorway or railway tunnel exhaust gases develop being potentially harmful for people near the concerned area.

In fact, by its nature, the exhausted gases move quickly, and may potentially contaminate a very huge area.

Then, in case of such events, there is the need to insulate the area concerned by the accident without creating loss of inlet or fluid-dynamic disorders, to limit as much as possible the consequences thereof, and/or to create an escape for people being in the surrounding areas.

The existing security systems generally act upon the cause of the accident but not upon its consequences. For example, the fire protection systems tend to put out the fire but have no effect on the exhaust gases developing therefrom.

From the Japanese patent application JP2004313753 an example of such security systems is known, which does not mention in any way the treatment of the exhaust gases as a consequence of an accident.

Even in the case of normal vehicular traffic there is still the need to treat the exhaust gases which develop in a tunnel, for example to abate the so-called fine dust (ie, powders having generally an average diameter lower than 10 μm), known to be harmful to human health, or the malodorous substances and/or unburnt particles therein.

From the European patent application EP1544408 a system for the evacuation of exhaust gases from a tunnel is known that includes the washing thereof through spurts of water to decrease the temperature. This document does not specify either the working pressure or the diameter of the water drops.

Furthermore, in the case of fresh air flowing in the tunnel there is the danger that dirt and/or foreign bodies enter in the ventilation duct of the tunnel, obstructing it.

### SUMMARY OF THE INVENTION

Object of the present invention is to at least partially overcome the above mentioned drawbacks by providing a system that allows to filter the exhaust gases flowing out from a tunnel and/or fresh air flowing therein, for example a road, motorway or railway tunnel, in a safe, effective and economic manner.

Another object of the invention is to provide a system to filter the exhaust gases flowing out from a tunnel and/or fresh air flowing therein having minimal environmental impact.

Another object of the invention is to provide a system that allows to filter the exhaust gases flowing out from a tunnel and/or fresh air flowing therein with minimum inlet losses.

Another object of the invention is to provide a system to filter the exhaust gases flowing out from a tunnel and/or fresh air flowing therein which is simple to manufacture.

Another object of the invention is to provide a system to filter the exhaust gases flowing out from a tunnel and/or fresh air flowing therein that has a relatively high time duration.

Another object of the invention is to provide a system to filter the exhaust gases flowing out from a tunnel and/or fresh air flowing therein that requires a minimum maintenance.

These objects, and others which will appear more clearly hereinafter are fulfilled by a system having one or more of the features herein described and/or claimed and/or shown.

Advantageous embodiments of the invention are defined in accordance with the appended claims.

### BRIEF DESCRIPTION OF THE DRAWINGS

Further features and advantages of the invention will become more evident reading the detailed description of some preferred not-exclusive embodiments of a system 1, which are shown as non-limiting example with the help of the annexed drawings wherein:

FIG. 1 is a schematic axonometric view of a system for the abatement of soot in a tunnel;

FIG. 2 is a schematic axonometric view of a tunnel T with a ventilation duct TV;

FIG. 3 is a sectioned view of a ventilation duct TV wherein an embodiment of system 1 is assembled;

FIG. 4 is a schematic view of certain components of the filtering means 20;

FIG. 5 is a schematic top view of an embodiment of system 1;

FIG. 6 is a schematic axonometric view of a further embodiment of system 1;

FIG. 7 is a schematic view of the assembly of the porous laminar element 220;

FIG. 8 is a schematic view of a working phase of the porous laminar element 220;

FIG. 9 is a section view of a ventilation duct TV wherein a further embodiment of the system 1 is assembled.

### DETAILED DESCRIPTION OF SOME PREFERRED EMBODIMENTS

With reference to the above mentioned figures, the system according to the invention, generally indicated with 1, is particularly useful for the filtration of exhaust gases flowing out from a tunnel T, for example the exhaust gases that develop as a result of a potentially dangerous accident, such as a fire or a gas leak, or the exhaust gases that develop in the tunnel as a result of vehicular traffic, whether it is more or less intense.

Certainly, the exhaust gases have a nature and a different composition due to the cause that generates them.

Generally, such exhaust gases direct a solid phase with more or less fine grains, nevertheless being always of micrometric size.

In case of fire, the exhaust gases may include a solid coarse phase, which normally consists of soot and possibly other coarse particles, and a solid fine phase, which normally consists of the so-called fine dust or PM10 (ie powders having generally an average diameter equal to or lower than 10 μm).

The solid coarse phase is generally formed by particles of an average diameter greater than 10 μm, usually up to 100 μm.

On the other hand, in the case of intense vehicular traffic the exhaust gases may comprise the only solid fine phase.

In any case, particularly if the tunnel is placed near an urban centre, there may be the need to abate the polluted unburnt particles and/or the malodorous substances of the exhaust gases.

The system 1 may be configured to abate from the exhaust gases one or more of the solid or fine phases or of the polluted unburnt particles and/or the malodorous substances above mentioned.

Furthermore, the system 1 may be useful to filter the fresh air flowing in the tunnel T, so as to prevent dirt and/or foreign bodies to enter therein.

Advantageously, the system 1 may be used in a tunnel T that stands above a roadway R, for example, a road tunnel, a motorway or a railway.

The system 1 may comprise one or more ports 300 fluidly connected to the outer environment A and one or more ports 310 fluidly connected to the tunnel T.

Depending on whether the system 1 is used for the filtration of the fresh air flowing in the tunnel T or for the exhaust gases flowing out from the tunnel T the one or more ports 300, 310 act as inflow or outflow for the filtered/to be filtered fluid.

Furthermore, the system 1 may comprise filtering means 20 interposed between the one or more ports 300, 310 and lying on the fluid line connecting them.

In a first embodiment, the system 1 may comprise detecting means of the accident having at least one sensor element, such as a fire sensor 10 or a fine dust sensor 10′ or an unburnt particles and/or malodorous substances sensor 10″, which may or may not be placed in the tunnel T, as appropriate. Then, alarm means may be provided, for example an alarm and/or a warning light 11.

Furthermore, control means 30 may be provided operatively connected to the detecting means and the filtering means to activate the latter in response to the detection of the potential danger of pollution by the former.

In a first embodiment, the control means may be manual, for example a lever or a button 30 that an operator manually activates once the sensor has detected the situation of potential danger and has set off the alarm 11.

However, to ensure maximum safety for the operators, the control means may be operable at distance with respect to the tunnel T. For example, an operations' station 31 may be provided spaced apart from the tunnel, wherefrom the operator may activate the button 30.

In this case, both the detecting means and the filtering means should be remotely connected to the operational centre 31, for example by wires or a wireless connection. In this way, the operator, once alerted by the alarm 11, may safely activate the filtering means.

Furthermore, to ensure the maximum rapidity of intervention, the control means 30 may be configured to automatically activate the filtering means 20 in response to the detection of the situation of potential danger. In this case, the treatment of the exhaust gases takes place in a totally automatic manner and without the need of operators.

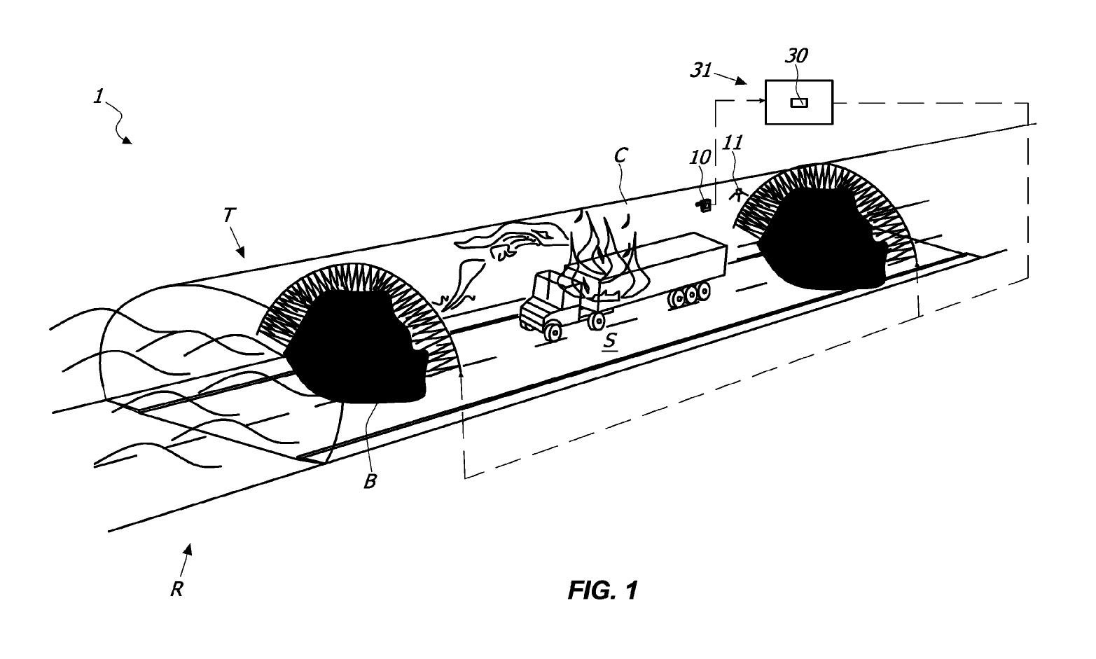

Advantageously, as shown in FIG. 1, in case of fire or gas leak the tunnel T may provide a atomized water system to abate soot, possibly being activated by the control means 30, susceptible to insulate the section S of the roadway R affected by the fire through barriers B of atomized water coming from the vault C of the tunnel T. This system may be manufactured in accordance with the teachings of the patent application VI2014A000162.

In this way, in case of fire it is possible to secure the upstream or downstream area of the section of the tunnel T where the same fire has occurred. In this way, it is possible to evacuate people safely and quickly, as well as to create a safe area for the means and the people involved in the rescue and recovery of the concerned area.

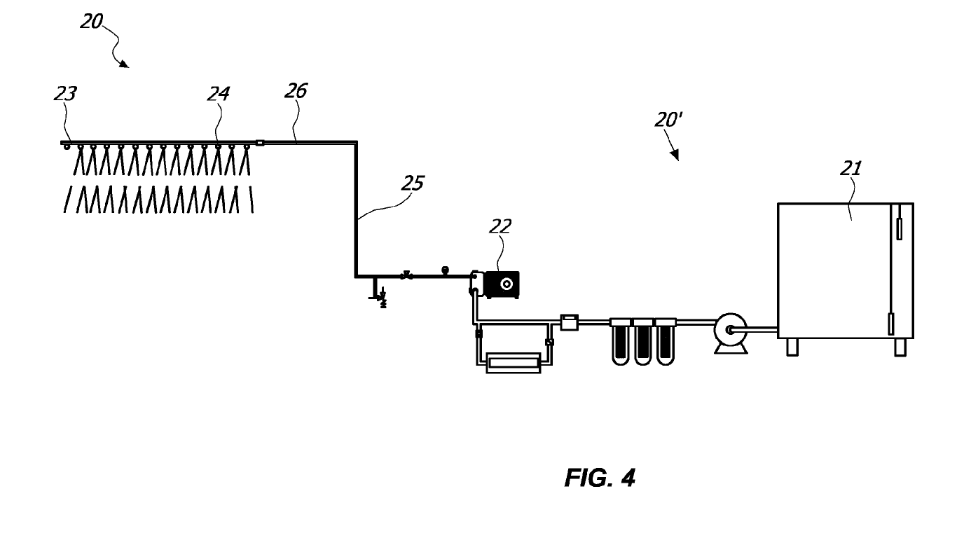

Suitably, as schematically shown in FIG. 4, the filtering means 20 may essentially comprise one or more water reservoirs 21, pumping means which include one or more high pressure pumps 22, preferably of the plunger type, and one or more collectors 23, each one comprising a plurality of high pressure nozzles 24 susceptible to spray atomized water into drops having an average diameter lower than 500 μm and at a minimum pressure of 150 bar.

Preferably, the average diameter of the drops of atomized water may be lower than 250 μm, while the minimum working pressure may be of 200 bar.

Suitably, furthermore, the nozzles 24 may be of stabilized flow type, manufactured according to the teachings of the patent application VI2014A000047.

Furthermore, to allow the water supply from the reservoir 21 to the nozzles 24 a line of fluid connection 25 may be provided passing through the pumping means and through the collector or collectors 23.

Moreover, to power supply the latter, the line 25 may include one or more supply pipes 26, one for each collector 23. Each supply pipe 26 may be independently power supplied by pumping means 22.

As shown hereinafter, the filtering means 20 may include one or more filtering units 20′, 20″, 20′″, which may have different functions according to the parameters of the atomized water used.

The high pressure atomized water is extremely effective as filtering means, and it allows to abate completely the soot that is emanated in case of fire or gas leak. Furthermore, it has no environmental impact, and it allows to have reduced inlet losses with respect to the classic sleeve or electrostatic filters.

It is understood that the system 1 may be used for both the above mentioned purposes, that is, for filtering both the fresh air flowing in the tunnel T and the exhaust gases flowing out from the tunnel T.

The same filtering unit 20′ may act both on the fresh air flowing in the tunnel T and on the exhaust gases flowing out from the tunnel T. On the other hand, the system may comprise one or more filtering units 20′, 20″, 20′″ to act upon the fresh air flowing in the tunnel T and one or more filtering units 20′, 20″, 20′″ to act upon the exhaust gases flowing out from the tunnel T.

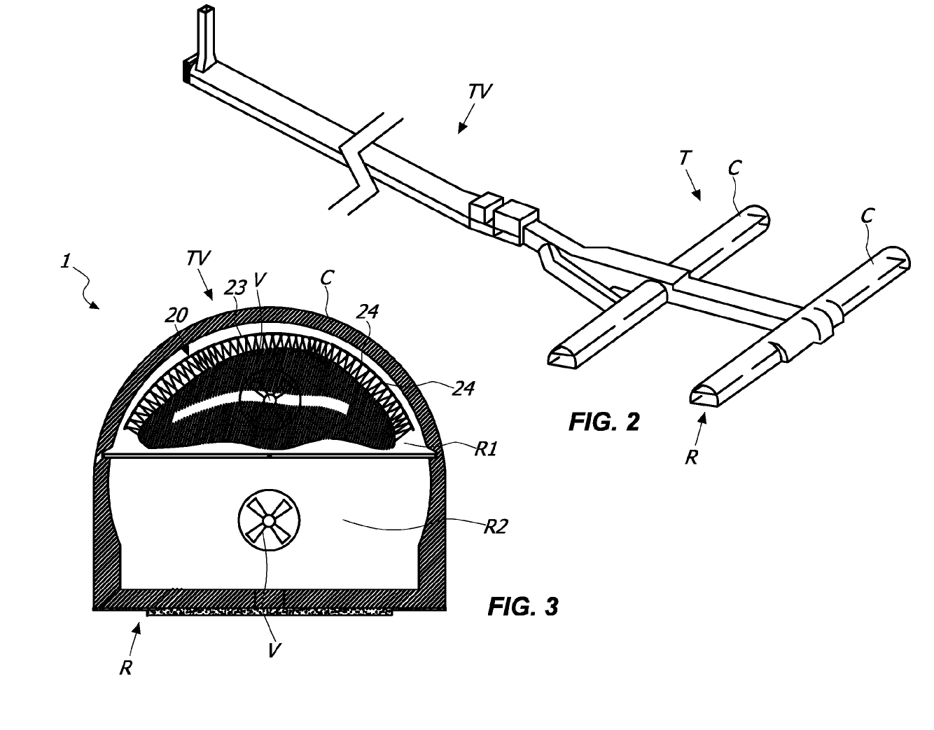

Advantageously, as shown in FIG. 2, the tunnel T may include one or more ventilation ducts TV, possibly transverse ventilation ducts, fluidly connected to the outer environment.

Each transverse ventilation duct may include a first branch R1 for the evacuation of the exhaust gases from the tunnel T towards the outer environment and a second branch R2 for the inflow of fresh air from the outer environment into the tunnel T. As shown in FIG. 3, the branches R1 and R2 may be overlapped.

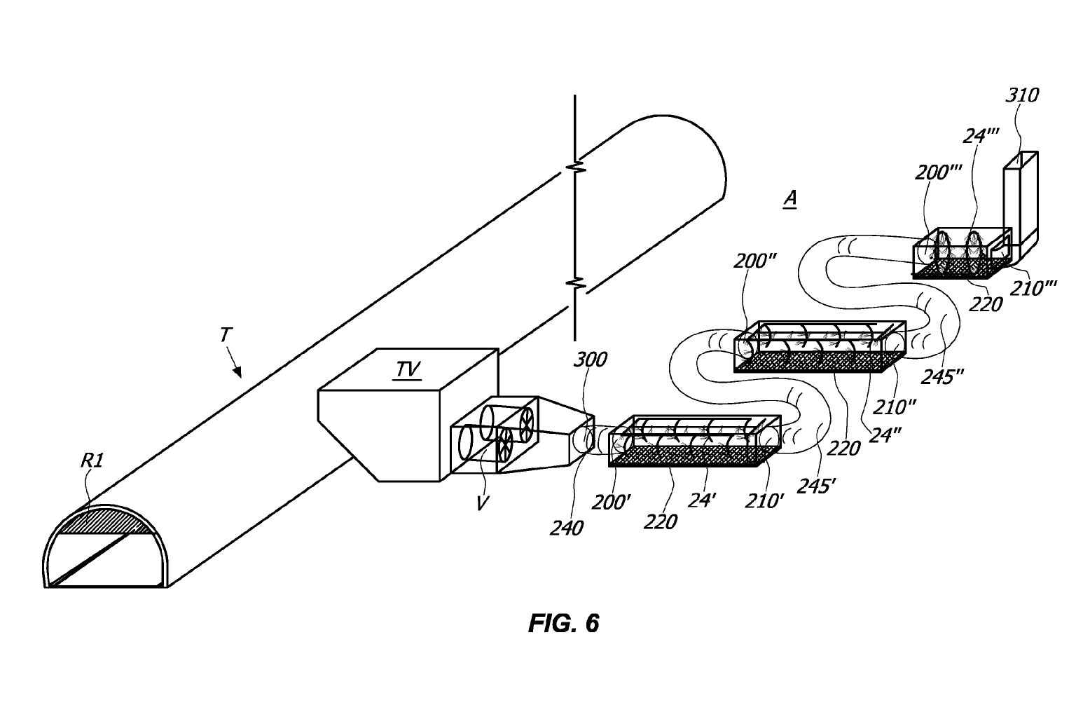

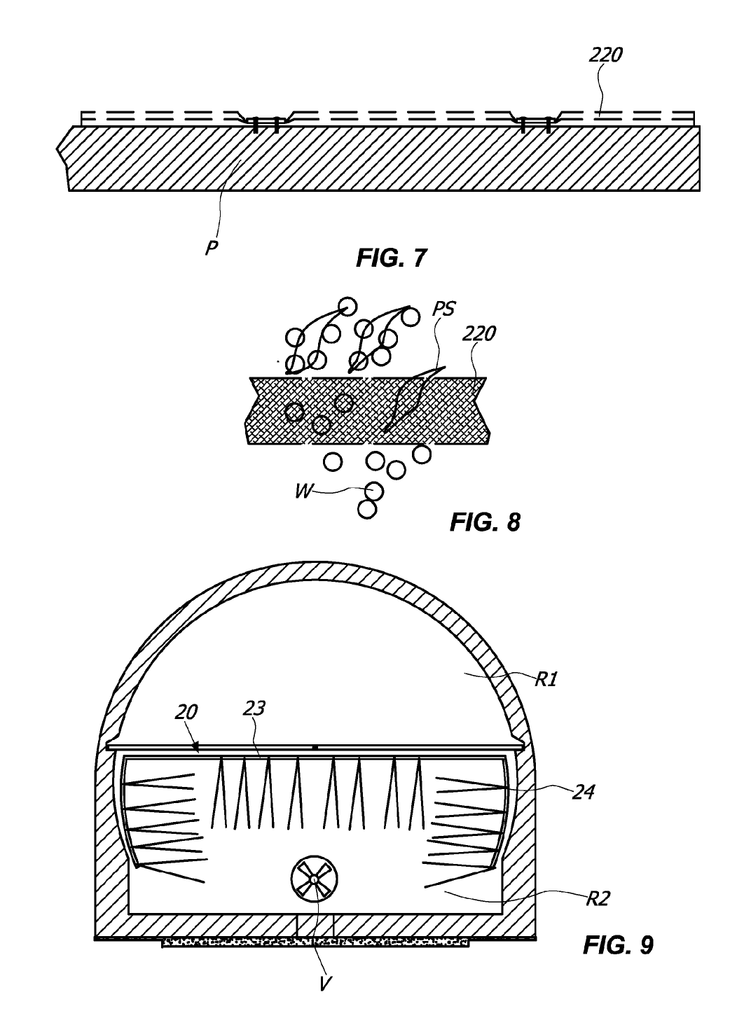

In a further embodiment, shown for example in FIG. 6, the ventilation duct TV may have smaller dimensions, mainly being formed by a ventilation chamber and a compartment wherein the fans lie.

In a known manner, the presence or absence of the transverse ventilation duct and, if present, its configuration depends on the features of the tunnel T, for example on its length, on the traffic that has to carry and on its geographical position.

Suitably, these transverse ventilation ducts TV may include fan means V, of known type, to force the evacuation of the exhaust gases from the tunnel T towards the outer environment and/or the inflow of fresh air from the outer environment towards the tunnel T. To the object, the ventilation means V may be placed in the branches R1 and/or R2.

In a preferred but not exclusive embodiment, the one or more collectors 23 with the relative high pressure nozzles 24 may be inserted in the transverse ventilation duct TV, and in particular in the branches R1 and/or R2.

Advantageously, where the fan means V are configured to force the inflow of fresh air from the outer environment towards the tunnel, the nozzles 24 may be susceptible to prevent the entry of dirt and/or foreign bodies therein.

Preferably, therefore, the nozzles 24 may be placed at the entry of the ventilation duct TV, with the fan means V placed downstream thereof along the forwarding direction of the fresh air from the outer environment A towards the tunnel T. However, there may be more filtering units in series, possibly with more fan means placed between two or more units.

Depending on requirements, the nozzles 24 may spray atomized water continuously, at predetermined time intervals or selectively, for example being controlled by the control means 30. Moreover, there may be a sensor that signals the possible entry of dirt or foreign bodies, possibly activating the nozzles 24 in an automatic way.

Suitably, in this case the average diameter of drops of the water is lower than 400 μm, preferably lower than 300 μm and more preferably lower than 200 μm.

Preferably, the minimum pressure may be of 200 bar, and even more preferably of 250 bar.

This allows to minimize the environmental impact of the filtering means, in addition to a considerable saving of water.

In this case, there may be one or more filtering units, which are identical or different. In the embodiment shown in the figures there is a single filtering unit 20′.

On the other hand, even where the fan means V are configured to force the evacuation of the exhaust gases from the tunnel towards the outer environment there may be one or more filtering units, which are identical or different.

In the preferred but not exclusive embodiment shown in the figures, the filtering means 20 may include more filtering units 20′, 20″, 20′″, fluidly connected in series. Each of them may have a specific function.

In particular, the first filtering unit 20′ may be susceptible to abate the solid coarse phase present in the exhaust gases, the second filtering unit 20″ may be susceptible to abate the solid fine phase (fine dust or PM10) present in the exhaust gases and the third filtering unit 20′″ may be susceptible to abate the malodorous substances and/or unburnt particles present in the exhaust gases.

Each one of the filtering units 20′, 20″, 20′″ may have a respective first, second and third inflow 200′, 200″, 200′″ for the exhaust gases to be treated and a respective first, second and third outflow 210′, 210″, 210′″ for the treated exhaust gases.

Advantageously, the control means 30 may be configured to selectively activate the different filtering units depending on the danger detected by the detecting means.

In particular, the control means 30 may activate all three filtering units 20′, 20″, 20′″ if the fire sensor 10 detects the presence of the first solid coarse phase and in particular of soot.

Since the same generally develops due to the fire, the sensor 10 may be a temperature or opacity sensor, respectively calibrated to give an alarm signal if the temperature or opacity detected exceed a predetermined threshold value. On the other hand, the sensor 10 may be susceptible to detect the presence of the solid coarse phase in a concentration greater than a predetermined threshold value.

Furthermore, the control means 30 may activate the only second and third filtering unit 20″ and 20′″ if the fine dust sensor 10′ detects the presence thereof in a concentration greater than a predetermined threshold value, which is generally fixed by law.

Moreover, the control means 30 may activate the only third filtering unit 20′″ if the unburnt particles and/or malodorous substances sensor 10″ detects these malodorous substances and/or unburnt particles exceeding a predetermined threshold value, which is generally fixed by law.

Suitably, the sensors 10, 10′ and 10″ may be connected together in cascade, so that if the first detects a potential danger the other two can not send signals and so forth.

In a preferred but not exclusive embodiment, the first filtering unit 20′ may include one or more porous laminar elements 220, which for example may be made of nonwoven polyamide or polyester fabric.

The use of the porous laminar element 220 is highly advantageous, since it allows to collect the entire solid coarse phase and in particular the soot, without losses in the exhausting water. To the object, the porosity of the porous laminar element 220 may be chosen so as to retain the solid particles PS and let the water W flow, as schematically shown in FIG. 8.

Once exhausted, the laminar element 220 may be replaced by a new one. To the object, the laminar element 220 may be assembled in a removable manner.

Advantageously, the porous laminar element 220 may be placed below the high pressure nozzles 24′ so that the mixture of water and solid coarse phase is collected by gravity thereto. To the object, the laminar element 220 may be assembled on the floor P of the ventilation duct TV or of the filtering units 20′, 20″, 20′″.

In a preferred but not exclusive embodiment, the porous laminar element 220 may have a permeability greater than or equal to 85 l/s m².

Suitably, the porous laminar element 220 may have a porosity not lower than 85%, with an average pores diameter of 100 μm.

Preferably, the porous laminar element 220 may be of the type susceptible to resist to high temperatures, indicatively with a maximum temperature of use of 210° C.

It is understood that even the other filtering units 20″ and 20′″ may include one or more laminar elements 220, which may be identical to those used for the filtering unit 20′ or different, for example having different porosity.

Advantageously, the exhaust gases and the atomized water flowing out from the first high pressure nozzles 24′ may be in counter-current between them inside the first filtering unit 20′. This allows a high efficiency of abatement of the solid coarse phase.

To selectively abate the solid coarse phase from the exhaust gases, the atomized water has to be sprayed at lower working pressures and into drops having an average diameter greater than the other filtering units 20″ and 20′″.

Therefore, the atomized water flowing out from the first high pressure nozzles 24′ may be in drops of an average diameter of 80 μm to 200 μm and may have a working pressure of 200 bar to 280 bar.

On the other hand, the atomized water flowing out from the second high pressure nozzles 24″ of the second filtering unit 20″ may be in drops of an average diameter of 5 μm to 30 μm and at a working pressure of 250 bar to 350 bar. Suitably, inside the second filtering unit 20″ the exhaust gases and the atomized water flowing out from the second high pressure nozzles 24″ may be in co-current.

Both the first and the second filtering unit 20′, 20″ act physically upon the exhaust gases, respectively abating in a selective manner the solid coarse phase and in particular the soot, and the fine one. To abate the unburnt particles and/or the malodorous substances, the third filtering unit 20′″ act both physically and chemically upon the exhaust gases, by oxidising these mixtures.

To the object, the system may comprise one or more containers 230 of an oxidising product, such as ozone, to be added to the water. In this way, from the third high pressure nozzles 24′″ atomized water is released supplied with the oxidising product.

Advantageously, the third filtering unit 20′″ may be configured so as the third high pressure nozzles 24′″ spray atomized water into drops having an average diameter of 5 μm to 30 μm and at a working pressure of 200 bar to 300 bar. Suitably, furthermore, the exhaust gases to be filtered and the atomized water flowing out from the third high pressure nozzles 24′″ may be in co-current and tangentially relative.

Preferably, each one of the filtering units 20′, 20″, 20′″ may include a respective support structure 205′, 205″, 205′″, for example a steel structure, and a respective high pressure pump 22′, 22″, 22′″ connected to a respective collector 23′, 23″, 23′″.

In a preferred but not exclusive embodiment of the invention, the at least one filtering unit 20′, 20″, 20′″ may be placed inside the ventilation duct TV of the tunnel T.

For example, the at least one filtering unit 20′, 20″, 20′″ may be placed at the entry of the ventilation duct TV.

On the other hand, in another embodiment, the at least one filtering unit 20′, 20″, 20′″ may be spaced apart from the tunnel T, externally thereto.

This embodiment is particularly useful in case the conformation of the tunnel T and the surrounding landscape is such to not allow the manufacturing of long ventilation ducts, such as in the case of towns tunnels T or tunnels placed nearby urban centres.

In this case, the filtering units 20′, 20″, 20′″ act as real filtering modules, that may be placed where the space surrounding the tunnel T allows it. For example, the filtering units or modules 20′, 20″, 20′″ may be assembled on support elements, for example steel towers, possibly in an above-ground position with respect to the tunnel T.

Then, depending on the space available, the filtering modules 20′, 20″, 20′″ may be assembled side by side or overlapped.

In this embodiment, the at least one filtering unit 20′, 20″, 20′″ may be fluidly connected to the tunnel T and/or to the ventilation duct TV thereof, possibly through one or more flexible pipes 240.

In case of more filtering modules 20′, 20″, 20′″, the same may be connected to each other through respective flexible pipets 245′, 245″.

Suitably, each filtering module 20′, 20″, 20′″ may be accessible by an operator for repair or maintenance, for example through a port or an appropriate passage.

In this case, the support structure 205′, 205″, 205′″ of each filtering module 20′, 20″, 20′″ may internally include the high pressure nozzles 24′, 24″, 24′″.

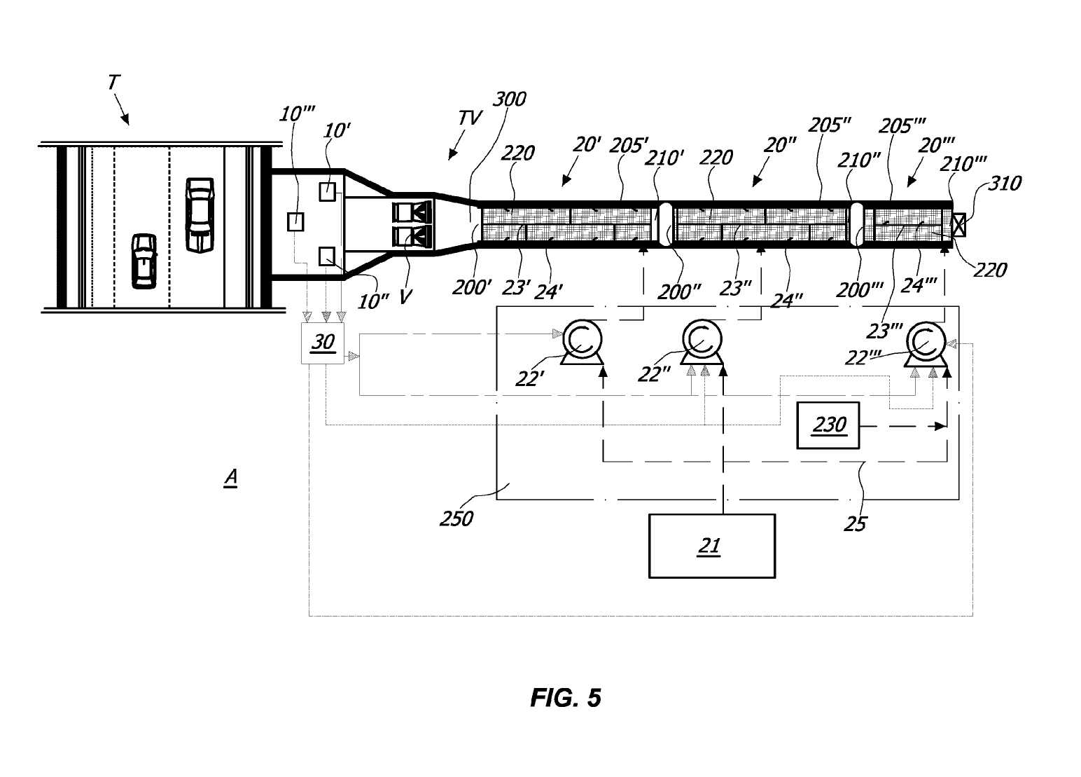

Furthermore, in a preferred but not exclusive embodiment, one or more operative modules 250 may be provided outside the tunnel T which contain the high pressure pumps 22′, 22″, 22′″. As particularly shown in FIG. 5, each filtering module 20′, 20″, 20′″ may be fluidly connectable with the operative module 250 and with a water reservoir 21.

It is understood that the above mentioned embodiment with the nozzles 24 susceptible to prevent the entry into the tunnel T of dirt and foreign bodies may further be manufactured with the filtering modules 20′, 20″, 20′″.

In other words, one or more filtering modules 20′, 20″, 20′″ may be provided susceptible to prevent the entry therein of dirt and foreign bodies. Certainly, in this case, the fan means V have to be configured to force the inflow of fresh air into the tunnel T.

From the above description, it is clear that the system 1 achieves the intended objects.

In particular, the system 1 allows the treatment of exhaust gases flowing out from and/or flowing in a tunnel T with minimum environmental impact, since it exclusively uses atomized water.

Furthermore, the system 1 allows the treatment of exhaust gases flowing out from and/or flowing in a tunnel T with minimum inlet losses, since there is almost no physical barrier to the forwarding of the exhaust gases.

Moreover, the system 1 is simple to manufacture and manage, it has a relatively high time duration and it requires a minimum maintenance.

The system 1 is susceptible of numerous modifications and variations. All the details may be replaced with other technically equivalent elements, and the materials may be different according to requirements, without departing from the scope of the invention defined by the appended claims. cm 1. A system for filtering fresh air flowing in a tunnel (T) overlying one roadway (R) and/or for filtering exhaust gases flowing out therefrom (T), comprising:
at least one first port (300, 310) fluidly connectable with the outer environment (A) for the flowing in of fresh air, respectively fluidly connectable with the tunnel (T) for the inflow of the exhaust gases, to be filtered;
filtering means (20) to filter the exhaust gases and/or the fresh air;
at least one second port (300, 310) fluidly connectable with the tunnel (T) for exhausting the fresh air, respectively fluidly connectable with the outer environment (A) for exhausting the filtered exhaust gases;
a first line for the fluid connection of said at least one first port (300, 310) and at least one second port (300, 310) passing through said filtering means (20);
fan means (V) to force the evacuation of the exhaust gases from the tunnel (T) towards the outer environment or the inflow of fresh air from the outer environment into the tunnel (T);
wherein said filtering means (20) comprise at least one filtering unit (20′, 20″, 20′″) that includes:
   at least one water reservoir (21);
   pumping means which include at least one high pressure pump (22);
   a plurality of high pressure nozzles (24) to spray atomized water into drops having an average diameter lower than 500 μm, preferably lower than 250 μm, and at a minimum working pressure of 150 bar, preferably at a minimum working pressure of 200 bar;
   a line (25) for the fluid connection of said at least one water reservoir (21) with said high pressure nozzles (24) passing through said pumping means (22).

2. System according to claim 1, wherein said at least one filtering unit (20′, 20″, 20′″) includes at least one porous laminar element (220) for the collection of residues of filtration of the exhaust gases and/or the fresh air.

3. System according to claim 2, wherein said at least one porous laminar element (220) is placed below said high pressure nozzles (24) to collect the mixture of water and filtration residues, the porosity thereof being such as to allow water to pass therethrough retaining the filtration residues.

4. System according to claim 2 or 3, wherein said at least one porous laminar element (220) is made of nonwoven polyamide or polyester fabric.

5. System according to claim 2, 3 or 4, wherein said at least one porous laminar element (220) is assembled in said at least one filtering unit (20′, 20″, 20′″) in a removable manner.

6. System according to any one of claims 2 to 5, wherein said at least one porous laminar element (220) has a permeability greater than or equal to 85 l/s m².

7. System according to any one of the preceding claims, wherein said fan means (V) are configured to force the evacuation of the exhaust gases from the tunnel (T) towards the outer environment (A), said at least one filtering unit (20′, 20″, 20′″) being susceptible to filter the exhaust gases flowing out from the tunnel (T) to pump filtered exhaust gases in the outer environment.

8. System according to any one of the preceding claims, wherein said at least one filtering unit (20′, 20″, 20′″) is a first filtering unit (20′) susceptible to abate a first solid coarse phase of the exhaust gases having a first predetermined minimum diameter, said first filtering unit (20′) comprising at least one first inflow (200′) for the exhaust gases with said first solid coarse phase, at least one first outflow (210′) for the exhaust gases free of said first solid coarse phase being provided.

9. System according to the preceding claim, wherein said first solid phase includes soot developing in the tunnel (T) as a result of a fire, said at least one parameter being the opacity and/or the temperature of the exhaust gases and/or the presence in the exhaust gases of said first solid coarse phase, said at least one porous laminar element (220) being susceptible to retain the first solid coarse phase when crossed by said exhaust gases.

10. System according to claim 8 or 9, wherein said first filtering unit (20′) is configured in such a manner so as said first high pressure nozzles (24′) spray atomized water into drops having an average diameter of 80 μm to 200 μm and at a working pressure of 200 bar to 280 bar.

11. System according to claim 8, 9 or 10, wherein said exhaust gases with said first solid coarse phase and the atomized water flowing out from said first high pressure nozzles (24′) flow in counter-current.

12. System according to any one of claims 8 to 11, wherein said at least one filtering unit (20′, 20″, 20′″) is a second filtering unit (20″) susceptible to abate a second solid fine phase of the exhaust gases having a second maximum predetermined diameter, said second filtering unit (20″) comprising at least one second inflow (200″) for the exhaust gases with said second solid fine phase and at least one second outflow (210″) for the exhaust gases free of said second solid fine phase.

13. System according to claim 12, wherein said second solid fine phase consists of particles having an average diameter lower than 10 μm that develop in the tunnel (T) as a result of vehicular traffic, said at least one parameter being the presence in the exhaust gases of said second solid coarse phase.

14. System according to claim 12 or 13, wherein said high pressure nozzles (24) are second high pressure nozzles (24), said second filtering unit (20″) being configured in such a manner that said second high pressure nozzles (24) spray atomized water into drops having an average diameter of 5 μm to 30 μm and at a working pressure of 250 bar to 350 bar.

15. System according to claim 12, 13 or 14, wherein said exhaust gases with said second solid fine phase and the atomized water flowing out from said second high pressure nozzles (24) flow in co-current.

16. System according to any one of claims 8 to 15, wherein said at least one filtering unit (20′, 20″, 20′″) is a third filtering unit (20′″) susceptible to abate malodorous substances and/or unburnt particles present in the exhaust gases, said at least one parameter being the presence in the exhaust gases of said malodorous substances and/or unburnt particles, said third filtering unit (20′″) comprising at least one third inflow (200′″) for the exhaust gases to be filtered and at least one third outflow (210′″) for the filtered exhaust gases, the system further comprising at least one container (230) of an oxidising product to be added to water to chemically act upon the exhaust gases to be filtered flowing in through said third inflow (200′″) so as to abate said malodorous substances and/or unburnt particles.

17. System according to claim 16, wherein said high pressure nozzles (24) are third high pressure nozzles (24′″), said line of fluid connection (25) fluidly connecting said at least one water reservoir (21) and said at least one container (230) of oxidising product with said third high pressure nozzles (24′″), said third filtering unit (20′″) being configured in such a manner that said third high pressure nozzles (24′″) spray atomized water into drops having an average diameter of 5 μm to 30 μm and at a working pressure of 200 bar to 300 bar.

18. System according to claim 16 or 17, wherein said exhaust gases to be filtered and the atomized water flowing out from said third high pressure nozzles (24′″) flow in co-current and tangentially relative.

19. System according to one or more of the preceding claims, wherein the system includes at least two of said first, second and third filtering unit (20′, 20″, 20′″) fluidly connected each other in series.

20. System according to claim 19, wherein the system includes said first, second and third filtering unit (20′, 20″, 20′″) fluidly connected between them in series so as the first outflow (210′) of the first filtering unit (20′) is fluidly connected to the second inflow (200″) of the second filtering unit (20″) and the second outflow (210″) of the latter is fluidly connected to the third inflow (200′″) of the third filtering unit (20′″), wherein said detecting means (10) include:
at least one first sensor (10′) to detect said first solid coarse phase;
at least one second sensor (10″) to detect said second solid fine phase;
at least one third sensor (10′″) to detect said malodorous substances and/or unburnt particles;
wherein said control means (30) are configured to activate manually or automatically in a selective manner:
said first, second and third filtering unit (20′, 20″, 20′″) if said at least one first sensor (10′) detects said first solid coarse phase;
said second and third filtering unit (20″, 20′″) if said at least one second sensor (10″) detects said second solid fine phase;
said third filtering unit (20′″) if said at least one third sensor (10′″) detects said malodorous substances and/or unburnt particles.

21. System according to one or more of the preceding claims, wherein said fan means (V) are configured to force the inflow of fresh air from the outer environment (A) towards the tunnel (T), said at least one filtering unit (20′, 20″, 20′″) being susceptible to filter the fresh air to prevent the entry of dirt and/or foreign bodies therein.

22. System according to claim 21, wherein the minimum pressure of atomized water in said at least one filtering unit (20′, 20″, 20′″) is of 200 bar, and even more preferably 250 bars.

23. System according to claim 21 or 22, wherein the average diameter of the drops of atomized water in said at least one filtering unit (20′, 20″, 20′″) is lower than 400 μm, preferably lower than 300 μm and even more preferably lower than 200 μm.

24. System according to one or more of the preceding claims, wherein the tunnel (T) includes a ventilation duct (TV) fluidly communicating with the same tunnel (T) and with the outer environment (A).

25. System according to claim 24, wherein the ventilation duct (TV) includes said at least one first port and at least one second port, said at least one filtering unit (20′, 20″, 20′″) being placed within the same ventilation duct (TV).

26. System according to one or more of the preceding claims, wherein said at least one filtering unit (20′, 20″, 20′″) is a filtering module (20′, 20″, 20′″) having a support structure (205′, 205″, 205′″) susceptible to be placed outside the tunnel (T) and/or the ventilation duct (TV) thereof.

27. System according to claim 26, wherein said filtering module (20′, 20″, 20′″) is fluidly connected to the tunnel (T) and/or to the ventilation duct (TV) thereof through one or more rigid or flexible pipes (240).

28. System according to claim 26 or 27, wherein said filtering module (20′, 20″, 20′″) is accessible by an operator for repair or maintenance.

29. System according to claim 26, 27 or 28, wherein said support structure (205′, 205″, 205′″) includes said at least one first port, said at least one second port and said plurality of high pressure nozzles (24).

30. System according to the preceding claim, wherein said support structure (205′, 205″, 205′″) includes a floor at which said at least one porous laminar element (220) is mounted.

31. System according to one or more of claims 26 to 30, comprising at least two filtering modules (20′, 20″, 20′″) overlapped or placed side by side fluidly connected between them through one or more rigid or flexible pipes (245′, 245″).

32. System according to one or more claims 26 to 31, further comprising at least one operative module (250) which is susceptible to be placed outside the tunnel (T) and/or to the ventilation duct (TV) thereof, said at least one operative module (250) including said at least one high pressure pump (22), said at least one filtering module (20′, 20″, 20′″) being fluidly connectable with said at least one operative module (250) and to said at least one water reservoir (21).

33. System according to one or more of the preceding claims, further comprising control means (30) to activate manually or automatically said filtering means (20).

34. System according to the preceding claim, wherein said control means (30) are spaced apart with respect to the tunnel (T).

35. System according to claim 33 or 34, further comprising detecting means (10) of at least one parameter of the exhaust gases and/or the fresh air, said control means (30) being susceptible to activate manually or automatically said filtering means (20) in response to the detection by the first (10) of the exceeding of a predetermined threshold value of said at least one parameter.

36. System according to the preceding claim, wherein said control means (30) are operatively connected to said detecting means (10, 11) and to said filtering means (20) to automatically activate the latter (20) in response to the detection by the former (10, 11) of the exceeding of the threshold value of said at least one parameter.
